(19) United States
(12) Patent Application Publication
(10) Pub. No.: US 2007/0296580 A1
(43) Pub. Date: Dec. 27, 2007

(54) Rfid Tag Theft Prevention Screening System, Tag And Base Station Therefor

(76) Inventor: Pierre Raimbault, Paris (FR)

Correspondence Address: YOUNG & THOMPSON, 745 SOUTH 23RD STREET, 2ND FLOOR, ARLINGTON, VA, 22202, US

(21) Appl. No.: 10/567,775

(22) PCT Filed: Aug. 2, 2004
(86) PCT No.: PCT/IB04/51553

§ 371 Date: Apr. 23, 2007

(30) Foreign Application Priority Data
Aug. 12, 2003 (FR) 0309884

(51) Int. Cl. G06K 7/00; G06K 19/077; G07G 1/00

(52) U.S. Cl. 340/572.1

(57) ABSTRACT

A method is provided for communicating between an electronic tag and at least two base stations, the electronic tag including a memory for storing a code having a plurality of levels, an apparatus for reading out a series of code values, at least one antenna for communicating with a base station, and a controller for responding to a read query from a base station by causing the read-out apparatus to read out the code values at at least one level, causing an antenna to transmit back a response signal and altering the code in the memory in response to a write query from a base station. In a write step, the electronic tag passes close to the first base station, and a base station proximity value is written into a predetermined code level. A transmission step is carried out when the electronic tag passes close to the second base station.

### TECHNICAL FIELD

The present invention concerns a process and a device for object recognition. It applies, in particular, to the identification of objects stolen within stores.

### BACKGROUND ART

There are systems already known where a reader (“base-station”) asks for responses from electronic tags; these are called “Reader Talk First” or “RTF” systems. The great majority of electronic-tags today are based on this principle.

### DISCLOSURE OF INVENTION

Technical Problem

These systems make it possible to “bulk” read objects equipped with tags. However, the reading is slow compared to the speed with which a person who has stolen an object in a store passes close to a portal. They are therefore not well suited to carrying out anti-theft functions, in particular when more than one product is stolen.

Other electronic tags have circuits that are destroyed when the object goes through the cash desk. These tags cannot be re-activated later, for example if the customer changes his or her mind or if he or she returns the product sold.

The aim of this invention is to remedy these inconveniences.

Technical Solution

To this end, the aim of this invention is, according to a first aspect, an electronic tag comprising:
a memory storing a code consisting of a plurality of ranks,
a reading means for successively reading code values in the different ranks,
at least one antenna communicating with a base-station and
control means adapted to, in response to a read request from a base-station, instruct the reading means to read the code value in at least one rank and to cause a response signal to be sent, in return, via an antenna, and, in response to a write request from a base-station, to modify the code in said memory,
characterized in that the control means are adapted:
when the tag passes close to a first base-station, to write a value representing the passage close to said first base-station in a pre-defined rank of the code and
in response to the first read request received from a second base-station, to instruct the reading means to read at least said rank of the code whose value represents the passage close to the first base-station and, via said antenna, to cause a signal representing the value read in said rank to be sent.

Thanks to these provisions, the first base-station being placed at the store's cash desk and the second base-station close to an exit from the store, if the tag is connected to a stolen object, then, when it passes close to the second base-station, the first response of the tag will be sufficient to determine that the object has not gone through the cash desk.

According to particular features, the control means are adapted to write, when the tag passes close to the first base-station, the value representing the passage close to the first base-station in a rank of the code that is read first by the second base-station during the read request received from said second base-station.

The detection of a theft is thus very quick: there is no need to wait for a second response from the tag in order to perform this detection.

According to particular features:
the control means are adapted to emit, via said antenna, a response signal during a time interval that depends upon the value read by the reading means and
the value representing the passage close to the first base-station in said pre-defined rank of the code is the value that corresponds, chronologically, to the first time interval for signal emission.

Thanks to these provisions, when it passes close to the second base-station, even if some objects have gone through the cash desk, the tag of a stolen object responds more rapidly than the tags of objects that have gone through the cash desk.

The aim of this invention is, according to a second aspect, a process of communication between an electronic tag and at least two base-stations, said electronic tag comprising:
a memory storing a code consisting of a plurality of ranks,
a reading means for successively reading code values in the different ranks,
at least one antenna communicating with a base-station and
control means adapted to, in response to a read request from a base-station, instruct the reading means to read the code value in at least one rank and to cause a response signal to be sent, in return, via an antenna, and, in response to a write request from a base-station, to modify the code in said memory,
characterized in that it comprises:
when the electronic tag passes close to the first base-station, a step where a value representing the passage close to said first base-station is written in a pre-defined rank of the code and
when the electronic tag passes closes to the second base-station, in response to the first read request received from the second base-station, a step where said tag sends a signal representing at least the value of said code in said rank whose value is representative of the passage close to the first base-station.

According to particular features, during the write step, when the tag passes close to the first base-station, the value representing the passage close to the first base-station is written in a rank of the code that is read first by the second base-station during the read request received from said second base-station.

According to particular features, the process as briefly described above comprises, in response to requests from the second base-station, a step where a response signal is emitted during a time interval that depends on the value of said code in a rank, the value representing the passage close to the first base-station in said pre-defined rank of the code having the value that corresponds, chronologically, to the first time interval for signal emission.

The present invention envisages, according to a third aspect, a base-station, called the “second”, for communicating with an electronic tag, said base-station comprising at least one antenna for sending read requests to said tag and receiving from the tag, in response, a signal representing the value in at least one rank of a code stored by said tag, characterized by comprising a means for detecting the absence said tag's passage close to another base-station, called the “first”, as a result of the first response emitted by said tag in response to a read request.

According to particular features, said means of detection is adapted to detect the absence of said tag's passage close to the first base-station when said first response is performed, chronologically, during the first time interval for signal emission.

The advantages, aims and characteristics of the second and third aspects of the present invention being similar to those of the first aspect, as briefly described above, they are not repeated here.

According to particular features of the base-station that is the object of the third aspect of this invention, said second base-station comprises at least two antenna pairs adapted to generate electromagnetic fields of different geometries and the base-station is adapted to cause signals to be emitted successively by each of said antenna pairs.

Thanks to these provisions, when a tag passes into an area in which an antenna pair is unable to communicate with it, another antenna pair, because its geometry is different from that of the first antenna pair, is likely to be able to communicate with said tag.

According to the particular features of the base-station that is the object of the third aspect of the present invention, said second base-station is adapted to order requests to be sent and responses to be received sequentially by antenna pairs of different geometries generating non-coplanar electromagnetic fields.

Thanks to these provisions, whatever the orientation of the tag might be, it is detected by the second base-station.

Other advantages, aims and characteristics of the present invention will become apparent from the description that will follow, made, as an example that is in no way limiting, with reference to the drawings included in an appendix, in which:

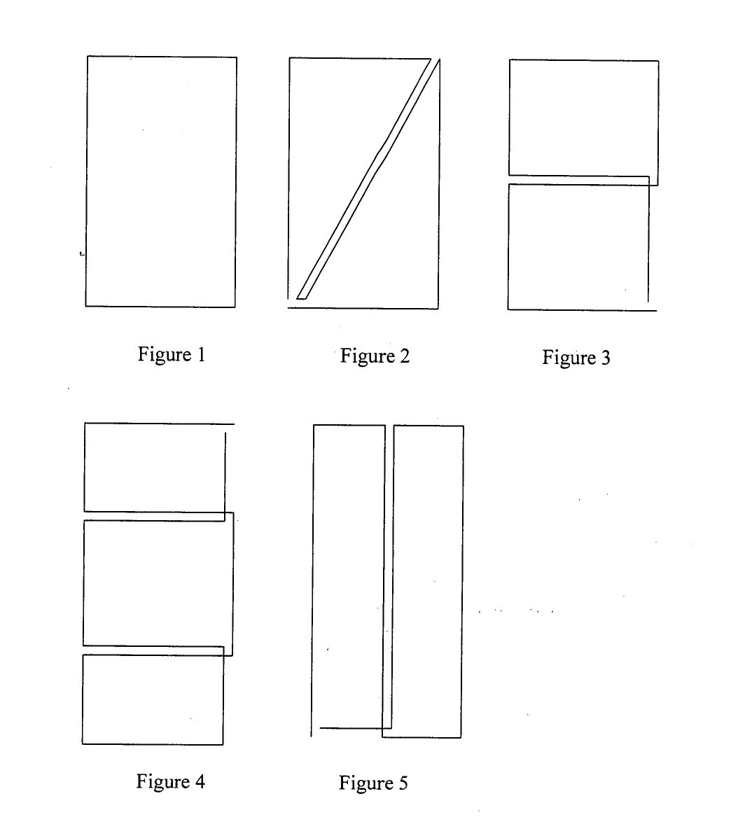

FIGS. 1 to 5 represent five forms of antennas,

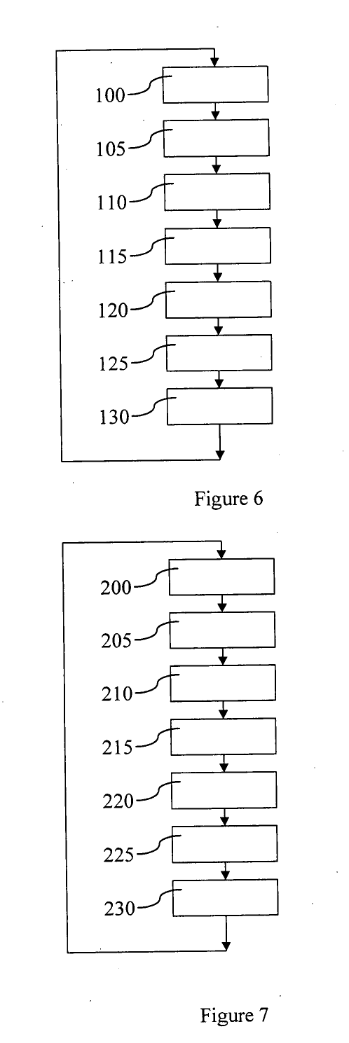

FIG. 6 represents the steps implemented by the two base-stations and a tag passing close to the aforementioned base-stations in succession, and

FIG. 7 represents the steps implemented by a base-station and a tag passing close to said base-station only.

Throughout the entire description, the term “close to” means at a distance at which a communication between an electronic tag and a base-station is established. It may therefore mean the same relationship between the tag and the base-station as “in the neighborhood of” in the sense of certain technical areas.

In order to better understand the operation and the communication between base-stations and tags, the reader should refer to patent applications FR 9514251, FR 9514252 and FR 9514253 (publication numbers FR 2 741 979, FR 2 741 980 and FR 2 741 978, respectively), which are included here as reference.

It is recalled that the “system”, that is to say the assembly comprising the base-stations and the electronic tags, uses synchronized communications between the reader and the tags, that is to say that the tags receive and communicate in perfect synchronization with the reader, which is preferential for implementing the present invention.

The information transmitted between a base-station and a tag is transmitted by amplitude modulation (Amplitude Shift Keying) carried by the power supply's magnetic field. For example, the system uses an amplitude-modulated transmission (called “ASK 50%”).

The system may thus transmit a series of commands or “requests” to the tags. A specific communications protocol carries out in succession:
the synchronization of all of the tags with the reader, and their phasing,
the check that there are tags to be identified in the sensitive volume,
the decoding of the codes of each of the tags present,
the locking of the tags that have been identified.

The system being a three-dimensional system, it repeats all the sequences described above in succession over the three axes, which we may schematically call: x, y and z.

The synchronization of tags is the subject of a specific paragraph below; here it is simply noted that it enables all the tags to send their response to the reader with the same phase, in order that all the signals emitted by the various tags are appended and that the interferences between them are constructive.

For the initialization of the identification sequence, the communications created between the reader and the tags is summarized here. The reader, via the magnetic field emitted, powers the tags appropriately positioned on a given axis. Of course, a tag that is not properly powered by the x-axis will, ipso facto, be properly powered by the y-axis or the z-axis. With a reader comprising three orthogonal axes, you can be sure a tag will be powered, whatever its orientation may be.

The first command sent to the tags is an “unlock” command, which unlocks all the tags present.

The system being the master and the tags being the slaves, the reader, or “the base-station”, then sends a message enabling the presence of at least one tag in the sensitive volume of the base-station's range to be checked for. All-the tags present send a presence datum to the reader.

Then the reader looks for the identifier of each tag in succession. When an identifier has been correctly detected by the reader, this latter sends a validation command indicating to the tags (or to the tag that has just responded) that their emission has been properly received.

The reception of this datum: “presence of active tags”, initiates the rest of the identification procedure. For example, the system works at the frequency of 125 kHz, which is best adapted to powering electronic tags, or “RFIDs”, in a large space (several m³). It is therefore easy to detect the tags' response, embedded in the noise by inter-correlation (via commercially-available DSP circuits).

The tags' response is sent on the coil that serves to power the tag and to transmit the commands (“information”). The tags, after having been synchronized and phased to the reader's clock, decode the commands and respond to the questions sent by the reader by “by-passing” one cycle out of two of the signal present at the terminals of the tag's coil (during a length of time programmed before-hand).

After synchronization, if the tags respond in phase, all the signals emitted by all the tags will be appended. Therefore, the more tags there are to be identified in the volume, the larger the received signals will be. Therefore the signal-to-noise ratio will be more favorable. This result is the reverse of what happens with anti-collision systems, where the more tags there are that respond, the more necessary it is to “optimize” the anti-collision system in order to extract a tag from the ambient noise.

Bulk identification in a volume is done for preference thanks to a determinist algorithm, which starts by sending a wake-up signal to all the tags appropriately powered by the axis concerned. The tags that are not appropriately powered are provisionally unable to respond to the reader and may do so only on another axis, on which they would be appropriately polarized.

The second instruction sent by the reader enables the provisional inhibits to be released and positions the address pointer of all the tags at address “0”. It is noted here that the code stored by each tag presents a plurality of ranks, either addresses or digits, and that each rank of the code may present a plurality of values.

The tags confirm their presence by sending a datum to the reader and put themselves on stand-by waiting for commands.

The reader then begins to identify the identifiers of the tags present; a command for the identification of the first digit is sent.

The tags respond, after having split the time into intervals of a fixed length. If the tag shows a “zero” in its first digit, it responds immediately in the interval following reception of the command. If the response is a “one”, the response takes place in the next interval, etc.

Once a tag responds it is therefore the tag with the smallest code; the tags that have not yet responded are provisionally inhibited, that is to say that they wait for a de-inhibit command before responding once more to the code value queries sent by the reader; this de-inhibit command may be implicit. The inhibit is possible because the reader validates the detection of a response by emitting a short impulse confirming to the tag which had just sent an emission that it had been detected properly. The other tags receive this validation signal and then present an inhibited status.

On receiving this emission confirmation, the tags that have just responded increment their address counter to point to the next address, which is to say, the next rank in their code. The reader tests this new value and validates the response received by emitting, again, a confirmation signal once it has received a response signal.

This is continued through to the last rank of the code, that is to say the digit with the highest weight, at which point the tag giving its code is frozen by the reader, which sends in this case a locking datum.

This locking command is immediately followed by a presence test command, which suppresses the temporary inhibits of the other tags and makes it possible, while there are still tags that are not locked and which are still not identified, to proceed with the identification of all the tags. The presence test command enables the inhibits to be suppressed and the address pointer to be positioned, at address “0”.

When no other tag responds to the sending of a presence test command, this means that no appropriately powered tag remains to be identified. The system therefore switches over to process the next axis, and so on.

The system comprises a particular synchronization of the tags, which detects what their electrical position is with regard to the reader's field. Depending on their respective position, they work on a clock identical to that transmitted by the reader, or else they work with a complementary clock (that is to say opposed in phase). Because of this, the responses transmitted by two tags normally opposed in phase should always be in phase for the reader, independent of the position of the tags, and all the responses may be appended.

An RFID tag comprises, very schematically, a coil (N turns of copper or aluminum wire wound to produce a flat coil), in the centre of which is placed the integrated circuit (IC). To create a traditional RFID board, and above all to reduce the magnetic field needed to power the IC, an extra capacity is added in parallel to the coil and the IC in such a way that this capacity tunes the coil's inductance very exactly to the work frequency in question.

Everything happens as if the circuit showed a gain. This latter thus generates a higher voltage to the coil's terminals than to the integrated circuit's terminals and may thus operate in a magnetic field weaker than the field without the addition of this capacity.

In bulk, this tuning capacity may not be used because a number of tags may be located very close to each other. The fact of two tags coming close to each other, and even more so when there are more than two, modifies the inductance of the coils that are close, which leads to de-tuning.

It is therefore not possible to work with the resonance to bulk identify tags considered to be close to each other.

The exit reader, or “second base-station”, is based on a technology with two symmetrical panels. Each panel is made up of a number of antennas (A, B, C, D, E, see FIGS. 1 to 5), which are powered sequentially (in turn) in order to generate a magnetic field in the entire defined space between the two panels.

As illustrated in FIGS. 1 and 5, the antenna 1A of panel 1 and the symmetrical antenna 2A of panel 2 are clustered in series or in parallel and powered by the same power board. If the antennas 1A and 2A are in series, they have the same current I generated by the power board running through them. If the two antennas 1A and 2A are in parallel, they have half of the current supplied by the power board running through them. The standard laws also apply for magnetic structures.

The choice of placing them in series or in parallel depends on the antenna's inductance value. The power boards are capable of handling inductances ranging from several dozen μH to several hundred μH.

For preference, in order to explore an entire space, in accordance with a preferential characteristic of the present invention, a number of antenna pairs are powered sequentially (in turn) in order to create a number of magnetic field directions at different times.

As indicated above, there are at least the following antenna pairs:
one antenna pair to create a magnetic field in the vertical direction;
one antenna pair to create a magnetic field in the direction front-to-back;
one antenna pair to create a magnetic field between the two panels;

Additionally, for large-sized structures (by panel height), and for preference, the structure is completed by additional coils in order to “cover” the entire height.

Of course these structures respect the standards in force based on the ETSI recommendations: ETS 300 330.

Respecting the standards, for forms of antenna that are slightly complex, such as “figure-of-eight” or “double figure eights”, imposes respect for the simple rules of symmetry. A “figure-of-eight” will always be cut through the middle ½, ½; a “double figure eight” will respect the proportions ¼, ½ and ¼. Otherwise, the fields created remotely would not respect the conditions imposed by the recommendation ETS 300 330.

The tags have integrated circuits for reading and writing (E2PROM chip with rewritable memory) and carry a unique identifier (UID), of 18 digits for example.

Initially, these read-only circuits are all programmed with a “zero” in the first digit. When a tag passes close to a first base-station, for example installed at a store's cash desk, the first base-station causes the first digit to be written with the highest value it could have, for example “eight”.

In accordance with the present invention, the reading of just the first digit by the second base-station only requires a very short time for identification, thus making it possible to carry out the anti-theft function (“EAS”) in three dimensions and by crossing the antenna of the second base-station's reader, or “exit reader”.

The tags currently having a minimum sensitivity of 4 μT, no zone exists where there would be a risk of the tag not being powered, and thus not being detected.

In order to detect the theft of objects, the codes stored by the tags represent passage close to the first base-station, at the cash desk. For preference, the detection of tags present in the volume is only done by means of the first digit; as has been seen above, its value depends on passage close to the first base-station. A multi-axis identification on a single digit allows a person to walk past without being stopped. On the other hand, the complete identification of the tags present requires a pause of several seconds (depending on the number of tags) in the passage through the exit reader, the second base-station.

On request from an employee, for example a member of the security staff, or automatically when a stolen object is detected, the system goes into identification mode, with the customer stopped between the panels, and provides the complete list of the code values of the tags present in the exit reader's field.

In a preferential embodiment, the tags that have not yet passed close to the first base-station (for example at the cash desk) have the same first digit, “zero” and the tags that have already passed close to the first base-station have a different first digit, “eight”.

The identification system carries out a sequential sweep of the 5 axes solely on the first digit so as to detect very quickly a tag that has not passed close to the first base-station.

When the second base-station (exit reader) identifies only tags that have a value of “eight”, the system gives a green light, thus authorizing the carrier of the tags to pass.

On the other hand, if the inductor identifies one tag (or more) whose first digit has a value of “zero”, the system triggers the emission of a red light, thus forbidding the carrier to pass, and this even if one tag (or more) whose first digit has a value of “eight” is identified as well.

The detection of a tag starting with a “zero”, and therefore “unauthorized”, has priority over any other detection.

### ADVANTAGEOUS EFFECTS

### DESCRIPTION OF DRAWINGS

This reader is associated with two panels, each of which comprises the five antennas illustrated in FIGS. 1 to 4.

For preference, the antennas that are capable of creating magnetic fields relatively easily because they are in the axis (or nearly so) of the coils are placed the furthest outside. Two antennas may be clustered in the same structure:
a Helmholtz coil made up of 5 turns,
a figure-of-eight in bias made up of 4 turns,

In fact, a Helmholtz coil allows a uniform magnetic field to be generated over the axis of the two coils, but respecting the 10-metre standards (ETS 300 330) greatly limits the current that might power large-size coils (0.9 m by 1.8 m). The Helmholtz coils are only there to create a field within the panels (see FIG. 2).

The figure-of-eight in, bias performs the necessary work by creating a magnetic field within the figure-of-eight, loops in compliance with ETS 300 330 recommendations However in the effective direction the field is null over the wire in bias. The Helmholtz coil remedies this situation.

A second layer corresponds to structures creating vertical magnetic fields. A figure-of-eight creates a field at the centre of the volume. A double figure eight enables fields to be created in the upper quarter and lower quarter (see FIG. 3).

A final layer (starting from the outside) has only a single coil creating a magnetic field from front to back of the sensitive volume. It corresponds to a vertical figure-of-eight (FIG. 4).

To avoid couplings between coils, the strands are separated (at least the centre of the strands) by 30 mm.

Interconnection between panels:
the figure-of-eight structures have all been connected in parallel in order to reduce the overall inductance values and
the Helmholtz coils are interconnected in series.

The connected panels have the following performances:

| | | Current in | Current in | | Tuning | Minimum |
|---|---|---|---|---|---|---|
| | Inductance | Ampere | each | Voltage in | capacity | magnetic |
| Axis | μH | peak | antenna | volts peak | in nF | field in μT |
| Figure-of-eight in | 75 | 9.10 | 4.55 | 469 | 28.67 | 4.5 |
| bias | | | | | | |
| Helmholtz | 261 | 3.37 | 3.37 | 600 | 8.24 | 17.0 |
| Horizontal | 176 | 4.70 | 2.35 | 570 | 12.20 | 11.3 |
| Double Figure | | | | | | |
| Eight | | | | | | |
| Horizontal | 133 | 6.50 | 3.25 | 590 | 16.12 | 6.50 |
| Figure-of-eight | | | | | | |
| Vertical Figure- | 178 | 4.36 | 2.18 | 530 | 12.04 | 4.36 |
| of-eight | | | | | | |

### BEST MODE

Mode For Invention

Industrial Applicability

In an operational mode, where the system has detected the passage of an unauthorized tag (first digit set to “eight”), the person carrying the tags is asked to stop between the panels of the exit reader.

The exit reader thus passes into identification mode (for example, by action on a switch provided for this purpose, or automatically after detection of a stolen object), that is to say that it reads the value of all of the codes of all of the tags present in its read zone. The system thus identifies all the digits comprising each identifier.

The 5 axes comprising the exit reader are powered sequentially. The identification is performed axis by axis. The identifiers of the tags powered on each axis are stored. At the end of the identification, the program performs the summarization and only displays the codes detected once, even if theses have been looked at several times.

There can be seen, in FIG. 1, an antenna 1, “Helmholtz”, in FIG. 2, an antenna 10, said to be “figure-of-eight in bias”, in FIG. 3, an antenna 11, said to be “horizontal figure-of-eight”, in FIG. 4, an antenna 12, said to be “double figure eight” and, in FIG. 5, an antenna 13, said to be “vertical figure-of-eight”.

As shown in FIG. 6, initially, step 100, by manufacture or at the moment the tags enter the store, all the tags have, in the rank of the code, for preference in the rank of the code that is read first by the second base-station, a pre-defined value, for preference the value which corresponds to the quickest response, that is to say, chronologically, to the first time interval available for the response, as a result of a query from the second base-station.

During a step 105, the tag enters into communication with the first base-station, for example, during the payment process of an object bearing said tag.

During a step 110, the first base-station instructs a value representing the passage close to said first base-station to be written in a pre-defined rank of the code. For preference, this pre-defined rank is the rank of the code that is read first by the second base-station. For preference, the first base-station writes, in the first rank read of the tag's code, a value corresponding to a slower response to a read request made by the second base-station than the value present in this rank at the end of step 100.

During a step 115, the tag enters into communication with the second base-station, for example at the store exit.

During a step 120, the second base-station orders the reading of the value of the code for at least the pre-defined rank where the first base-station is likely to have written during the course of the step 110, for preference the first rank read by the second base-station.

During a step 125, the tag responds to the second base-station, if no other tag has responded before it, and supplies it with the value of the code in this rank, which is, in the case illustrated in FIG. 6, the value written in this rank of the code by the first base-station during the step 110.

The second base-station may then determine if the object has been stolen, by retrieving the value written by the first base-station during the step 110. In the preferential embodiment in which the value written by the first base-station has been written in the rank that is read first by the second base-station, the detection of theft is rapid.

In the most preferred embodiment in which because this tag has, in the rank of the code that is read first, the value that corresponds to a slower response than a tag of a stolen object, that is to say, chronologically, to an interval other than the first time interval available for the response, a tag of a non-stolen object (situation for FIG. 6) has a slower response than a tag of a stolen object (situation for FIG. 7), as a result of a query from a second base-station. Thus, during a step 130, the second base-station ascertains that the object has not been stolen and triggers the display of a “green light”.

As shown in FIG. 7, initially, step 200, by manufacture or at the moment the tags enter the store, all the tags have, in the rank of the code, for preference in the rank of the code that is read first by the second base-station, a pre-defined value, for preference the value which corresponds to the quickest response, that is to say, chronologically, to the first time interval available for the response, as a result of a query from the second base-station.

During a step 205, the tag enters into communication with the second base-station, for example at the store exit.

During a step 210, the first base-station instructs the value of the code for the first rank read to be read.

During a step 215, the tag responds to the second base-station, if no other tag has responded before it, and supplies it with the value of the code in this rank, which is, in the case illustrated in FIG. 7, the value present, in this rank of the code, at the end of the step 200.

The second base-station may then determine if the object has been stolen, by retrieving the value present at the end of the step 200. In the preferential embodiment in which the value written by the first base-station has been written in the rank that is read first by the second base-station, the detection of theft is rapid.

In the most preferred embodiment in which because this tag has, in the rank of the code that is read first, the value that corresponds to a quicker response than a tag of a non-stolen object, that is to say, chronologically, to the first time interval available for the response, a tag of a stolen object (situation for FIG. 7) has a quicker response than a tag of a non-stolen object (situation for FIG. 6), as a result of a query from a second base-station. Thus, during a step 220, the second base-station ascertains that the object has been stolen and triggers the display of a “red light”.

Either automatically, or at the request of a user (for example, a member of the security staff), the second base-station then triggers the reading of all of the codes of all of the objects with which the second base-station might communicate, step 225, and indicates which objects have been paid for and which objects have been stolen, step 230.

It is noticed that, for preference, the information read by the second base-station in order to determine the theft of an object is not the tag's unique identifier, but another field stored in the tag's memory.

In the preferential embodiment, the second base-station then reads the rank of the code which corresponds to this code first and, even more preferentially, the value of the code in this rank is less for a tag associated with an object that has not passed close to the first base-station than for an object that has passed close to the first base-station.

1-10. (canceled)

11. Base-station for interrogating electronic tags, that comprises at least one reader adapted to transmit a series of requests to said electronic tags by means of at least one antenna made up of a coil of conducting wires, each coil encompassing at least two parts around which current circulates, in the coil, in two opposite directions.

12. Base-station according to claim 11, wherein at least one of said coil has a symmetrical form.

13. Base-station according to claim 11, wherein the coil of at least one antenna extends over a rectangular shape and passes noticeably through the middle of said rectangular shape so as to separate two of said parts.

14. Base-station according to claim 13, wherein said coil passes through the middle of said rectangle parallel to one side of said rectangular shape so as to separate two of said parts having rectangular shapes of identical dimensions.

15. Base-station according to claim 13, wherein said coil passes through the middle of said rectangle along a diagonal of said rectangle so as to separate two of said parts having triangular shapes of identical dimensions.

16. Base-station according to claim 11, wherein the coil of at least one antenna extends over a rectangular shape and passes two times across said rectangle so as to separate three of said parts around which the current circulates, in the coil, alternately, in opposite directions.

17. Base-station according to claim 16, wherein one of said three parts has a rectangular shape and presents a surface that is noticeably equal to an half of the surface of said antenna and is surrounded by two of said parts, each of said two parts having a rectangular shape and presenting a surface that is noticeably equal to a quarter of the surface of said antenna.

18. Base-station according to claim 11, wherein information transmitted between a base-station and a tag is sent in amplitude modulation of a magnetic field generated by the coil.

19. Base-station according to claim 11, that comprises at least one antenna associated to each of three axes perpendicular to each other, the reader being adapted to repeat a sequence of requests successively with different antennas.

20. Base-station according to claim 19, wherein said sequence of requests is limited just to a binary datum stored by the electronic tags.

21. Base-station according to claim 20, wherein the reader is adapted to determine a value of the binary datum according to a time interval during which an electronic tag responds.

22. Base-station according to claim 20, wherein, if said binary datum is a pre-defined value, the reader discontinues the sequence of requests and reads an identifier of the electronic tag.

23. Base-station according to claim 22, wherein said pre-defined value represents the absence of passage close to another base-station.

24. Base-station according to claim 22, wherein said pre-defined value is, chronologically, represented in the first time for signal emission by an electronic tag.

25. Base-station according to claim 11, that comprises two symmetrical panels comprising similar antennas.

26. Base-station according to claim 11, wherein the reader is adapted to receive responses from said electronic tags on each antenna.

27. Base-station according to claim 26, wherein the reader is adapted to detect attenuation, during a pre-defined length of time, of one cycle out of two, said attenuation being performed by an electronic tag.
